(19) United States
(12) Patent Application Publication
(10) Pub. No.: US 2015/0195345 A1
(43) Pub. Date: Jul. 9, 2015

(54) DISPLAYING ROLE-BASED CONTENT AND ANALYTICAL INFORMATION

(71) Applicant: Microsoft Corporation, Redmond, WA (US)

(72) Inventors: John P. Burrows, Bothell, WA (US); Michael M. Santos, Seattle, WA (US)

(73) Assignee: Microsoft Corporation, Redmond, WA (US)

(21) Appl. No.: 14/151,323

(22) Filed: Jan. 9, 2014

(51) Int. Cl. H04L 29/08; H04L 29/06; G06Q 10/06; G06F 3/0482

(52) U.S. Cl. CPC H04L 67/10; G06F 3/0482; H04L 67/42; G06Q 10/06393

(57) ABSTRACT

A user interface display has one or more metrics or performance indicator elements. The elements are actuatable to display more detailed information corresponding to each metric or performance indicator. A plurality of different pre-defined display elements can be added to the display.

### BACKGROUND

Computer systems are currently in wide use. In fact, they are in use in many different types of environments.

Some such computer systems include business computer systems. Business systems include, for example, customer relations management (CRM) systems, enterprise resource planning (ERP) systems, line-of-business (LOB) systems, etc. These types of systems often include business data that is stored as entities or other business data records. Such business data records (or entities) often include records that are used to describe various aspects of a business. For instance, they can include customer entities that describe and identify customers, vendor entities that describe and identify vendors, sales entities that describe particular sales, quote entities, order entities, inventory entities, etc. The business systems also commonly include process functionality that facilitates performing various business processes or tasks on the data. Users log into the business system in order to perform business tasks for conducting the business.

Such business systems also currently include roles. Users are assigned one or more roles, based upon the type of tasks they are to perform for the business. The roles can include security permissions, and they can also provide access to different types of data records (or entities), based on a given role.

Business systems can also be very large. They contain a great number of data records (or entities) that can be displayed or manipulated through the use of thousands of different forms. Therefore, visualizing the data in a meaningful way can be very difficult.

Employees in different roles in an organization may also wish to view different information. That information can be generated using fairly complex analytical processing. For instance, business intelligence systems, and online transaction processing (OLTP) systems, can be employed in order to perform relatively complicated operations or calculations on underlying business data. This can give a manager a desired view of the data or provide the manager with other desired information. The desired information can include, for instance, a variety of different business metrics which can be used to measure the progress or success of the organization, or other items.

The business intelligence and OLTP systems often include relatively complex user interfaces that can be configured to generate the various metrics. It normally takes an individual who is trained in the particular language or techniques used by the business intelligence system or OLTP system in order to configure it to generate the desired information.

The discussion above is merely provided for general background information and is not intended to be used as an aid in determining the scope of the claimed subject matter.

### SUMMARY

A user interface display has one or more metrics or performance indicator elements. The elements are actuatable to display more detailed information corresponding to each metric or performance indicator. A plurality of different pre-defined display elements can be added to the display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system.

FIG. 2 is a flow diagram illustrating one embodiment of the overall operation of the system shown in FIG. 1 in generating and manipulating a practice manager display.

FIGS. 2A-2G show a plurality of different exemplary user interface displays.

FIG. 3 is a flow diagram illustrating one embodiment of the operation of the system shown in FIG. 1 in manipulating a chart display.

FIG. 3A shows one embodiment of a user interface display illustrating a chart gallery.

FIG. 4 is a flow diagram illustrating one embodiment of the operation of the system shown in FIG. 1 in manipulating a key performance indicator (KPI) display.

FIG. 4A-4C show various embodiments of user interface displays.

FIG. 5 shows one embodiment of a user interface display for sorting entities.

FIG. 6 shows one embodiment of the system shown in FIG. 1 deployed in a cloud computing architecture.

FIGS. 7-12 shown various embodiments of mobile devices.

FIG. 13 is a block diagram of one illustrative computing environment.

### DETAILED DESCRIPTION

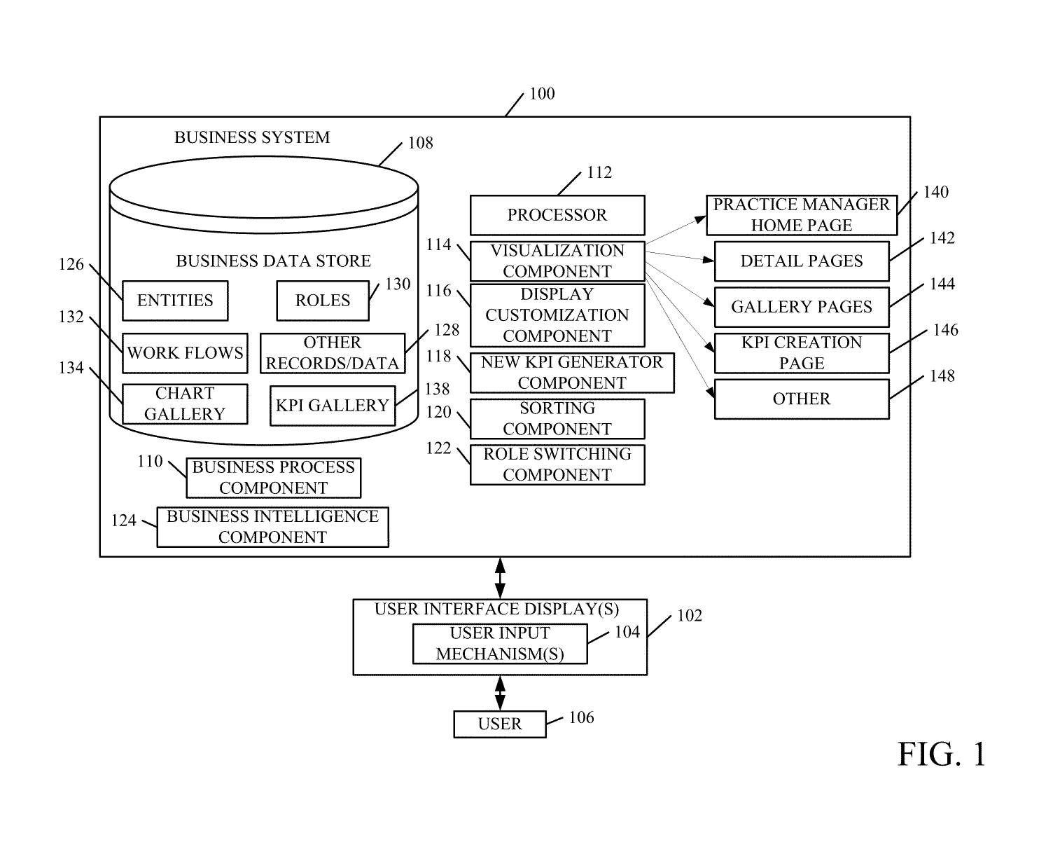

FIG. 1 is a block diagram of one embodiment of a business system 100. Business system 100 generates user interface displays 102 that have user input mechanisms 104 for interaction by user 106. User 106 illustratively interacts with the user input mechanisms 104 to control and manipulate business system 100.

Business system 100 illustratively includes business data store 108, business process component 110, processor 112, visualization component 114, display customization component 116, key performance indicator (KPI) generator component 118, sorting component 120, role switching component 122 and business intelligence component 124. Business data store 108 illustratively includes business data for business system 100. The business data can include entities 126 or other types of business records or data 128. It also includes a set of roles 130 that can be held by various users of the data system 100. Further, business data store 108 illustratively includes various workflows 132. Business process component 110 illustratively executes the workflows 132 on entities 126 or other business data records 120, based upon user inputs from users that each have one or more given roles 122. Business data store 108 is also shown as including chart gallery 134 and KPI gallery 136. Galleries 134 and 136 illustratively store pre-defined user interface display elements that can be selected for display by user 106.

Visualization component 114 illustratively generates various visualizations, or views, of the data and processes (or workflows) stored in business data store 108. The visualizations can include, for example, practice manager homepage display 140, detail pages 142, gallery pages 144, KPI creation page 146, and it can include other displays 148 as well.

Practice manager homepage display 140 is illustratively an overview of the various data and workflows in business system 100 that are relevant to a practice manager. It can surface charts, key performance indicator display elements, and entity display elements. Detail pages 142 illustratively display more details about a particular item that was actuated by the user from the homepage display 140. Gallery pages 144 illustratively display pre-defined display elements that can be added by user 106 to the homepage display 140. KPI creation page 146 illustratively presents a user experience that allows user 106 to create new KPI display elements that can display new or different key performance indicators on homepage 140.

Business intelligence component 124 illustratively performs analytics or other business intelligence operations on the data in business data store 108 in order to generate information that can be used by visualization component 114 and displayed on charts or on key performance indicator display elements. As an example, if a chart is configured to display utilization versus time, business intelligence component 124 illustratively calculates the information needed by visualization component 114 to generate and display that chart. Similarly, if a key performance indicator is actual cost as compared to the cost for a previous month and as compared to a budgeted cost, business intelligence component 124 illustratively performs the calculations needed by visualization component 114 in order to generate that display.

Display customization component 116 illustratively allows user 106 to perform various customization operations on the displays generated by visualization component 114. That is, user 106 can provide inputs on user input mechanisms to customize the various displays.

New KPI generator component 118 illustratively generates user interface displays (e.g, KPI creation page 146) that allow user 106 to configure new KPI display elements that can be displayed on practice manager homepage 114 and reflect desired KPIs. Sorting component 120 illustratively receives inputs from user 106 to sort the information displayed on various displays. Role switching component 122 illustratively allows user 106 to switch roles, if the user is authorized to do so. Component 122 then provides this information to visualization component 114 so that visualization component 114 modifies the role-based information that is displayed, as appropriate.

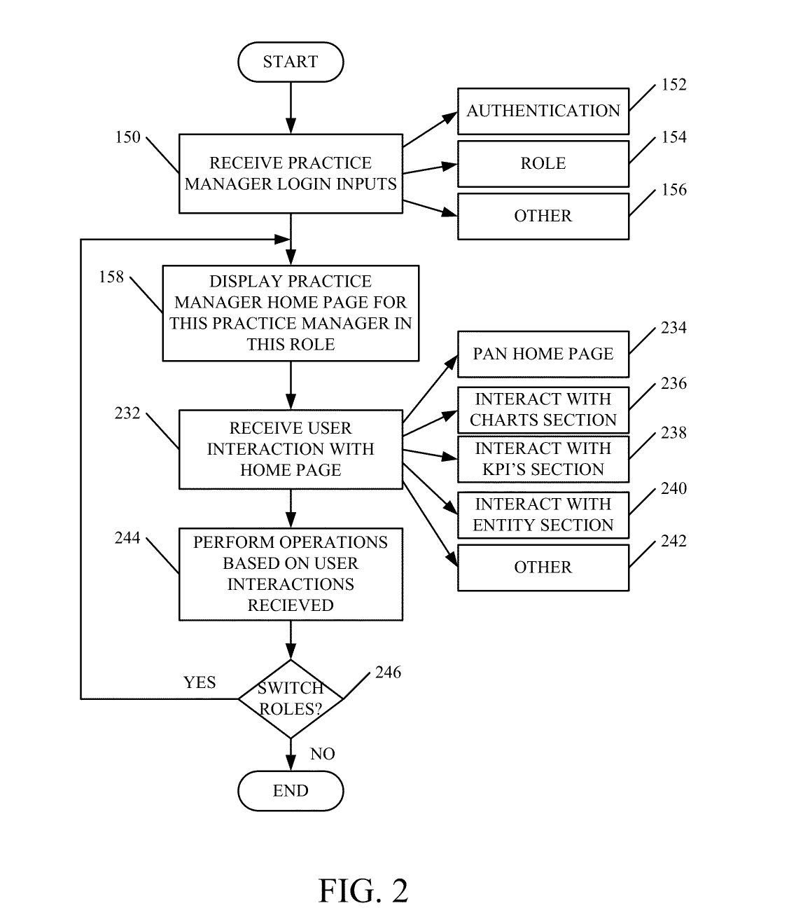

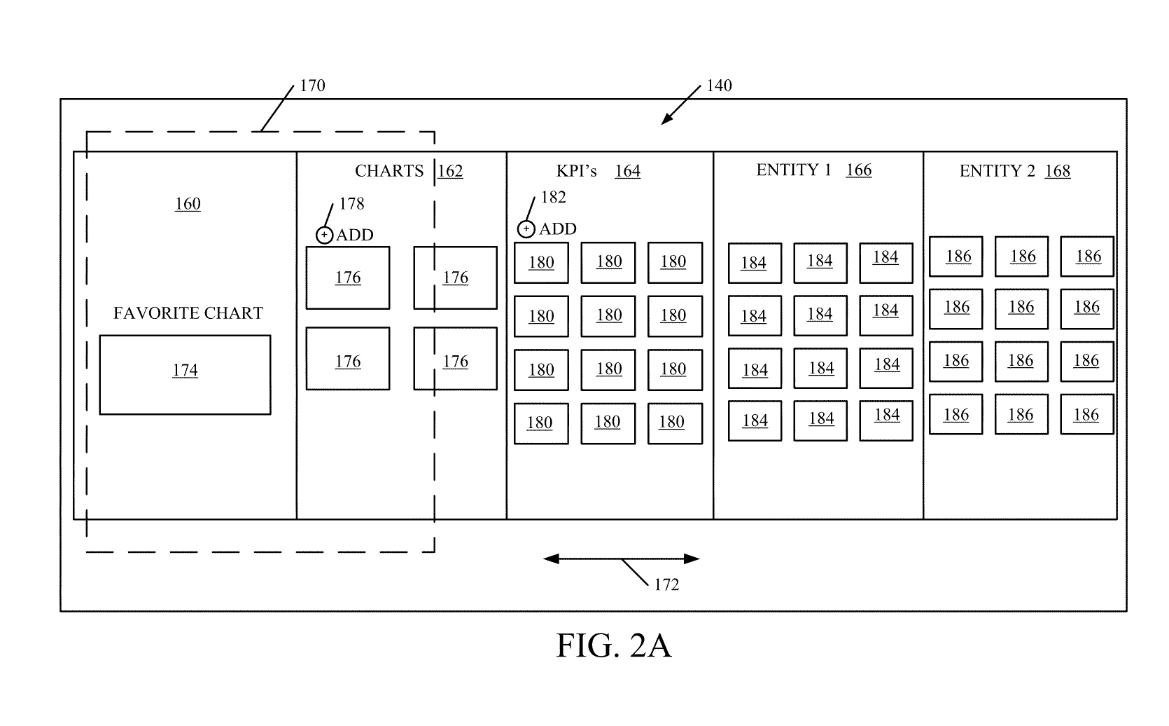

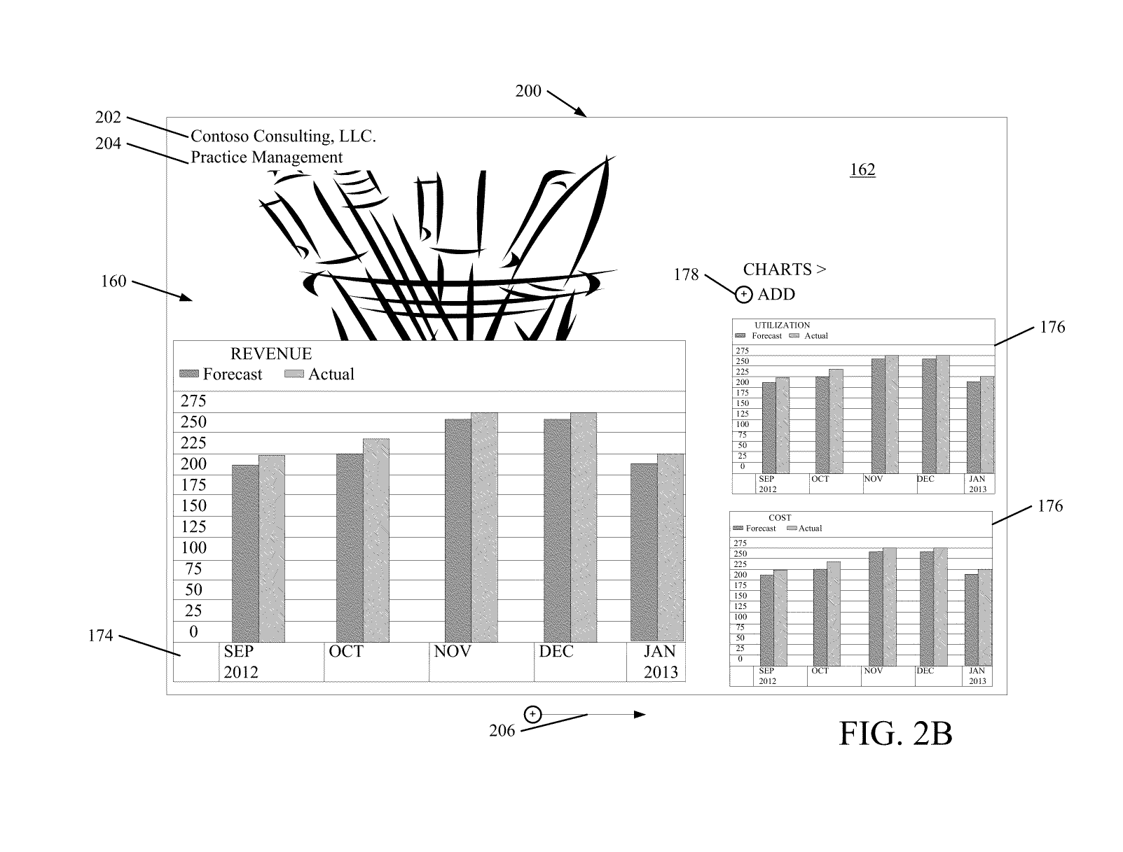

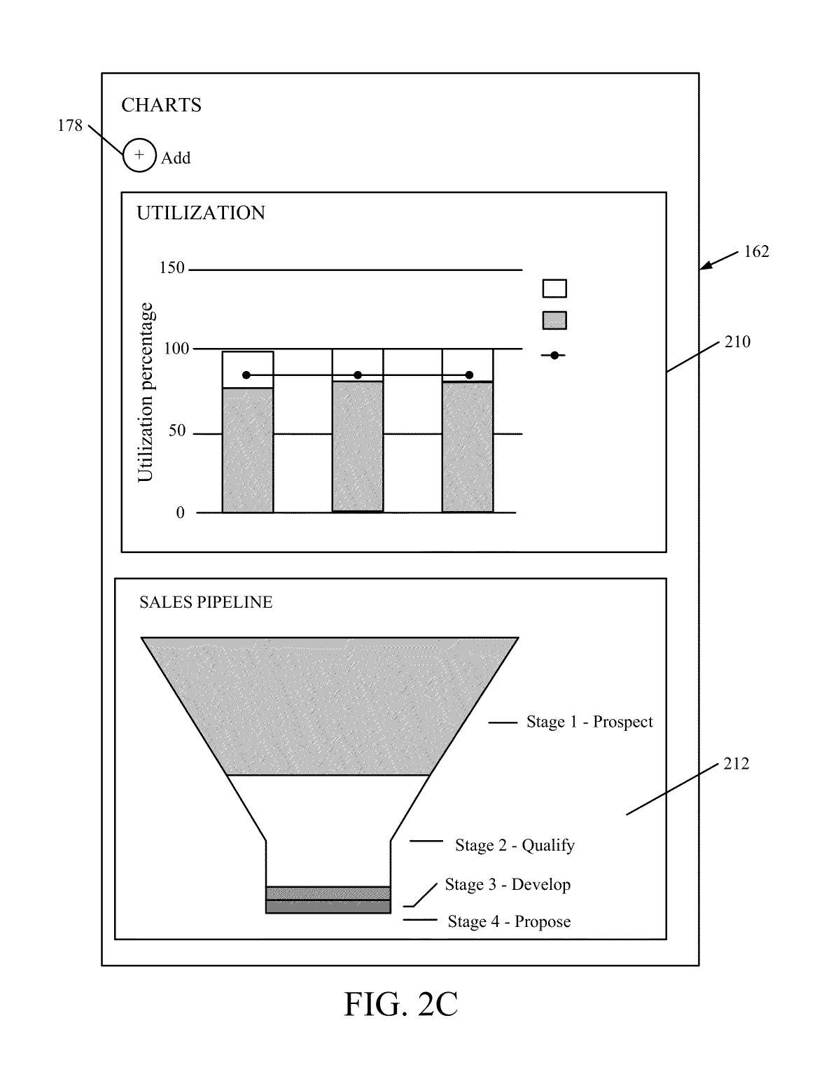

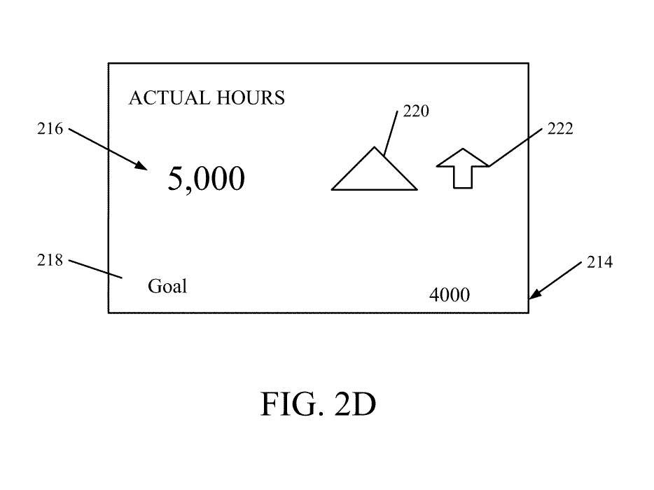

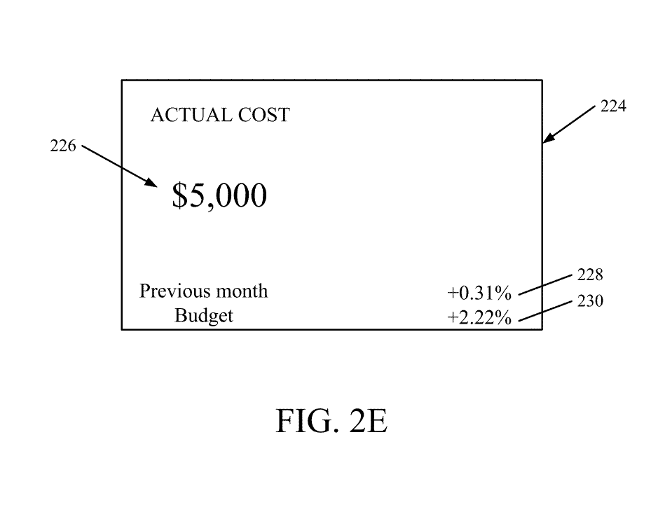

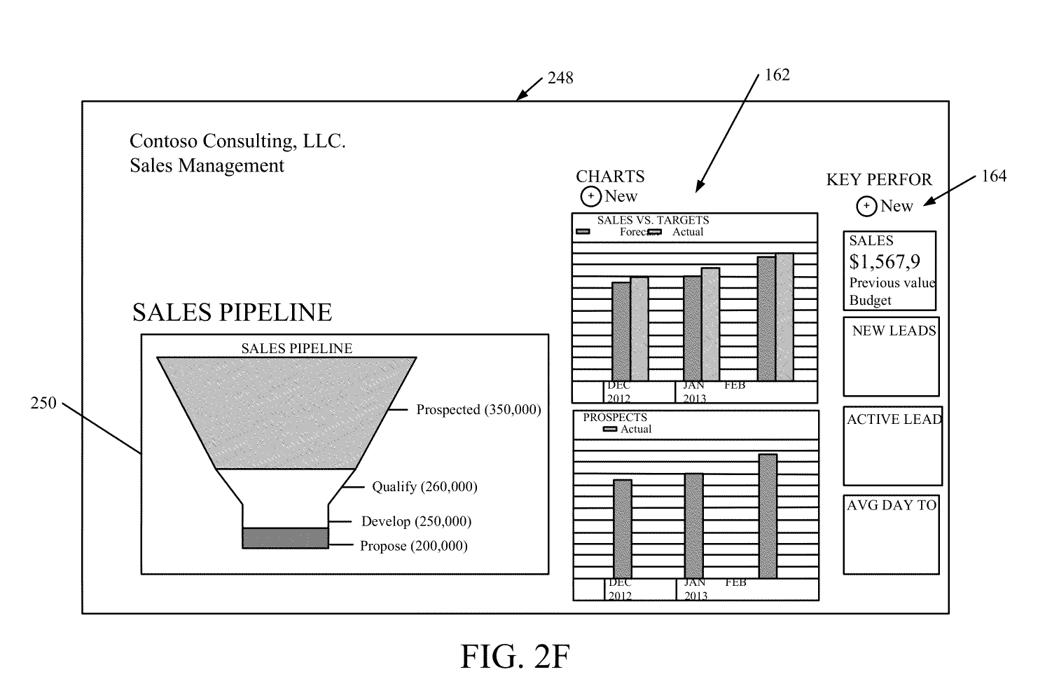

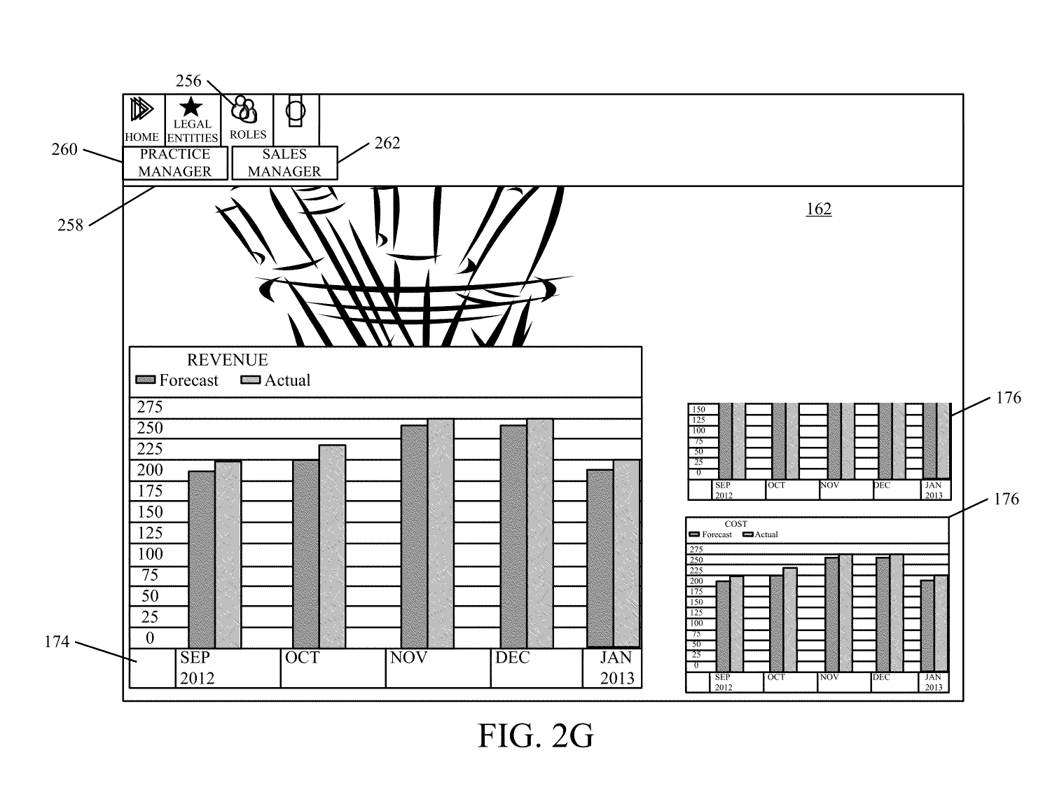

FIG. 2 is a flow diagram illustrating one embodiment of the overall operation of business system 100 in generating the various displays 140-148. In one embodiment, each user 106 is assigned a role 122, based upon the types of activities or tasks that the given user 106 will perform in business system 100. Thus, in one embodiment, business system 100 first receives login inputs from user 106, who is currently in the role of a practice manager. A practice manager is a management professional who coordinates the functions of a private practice. They can, for instance, work with other professionals in the organization to develop business plans and run business operations. Receiving practice manager login inputs is indicated by block 150 in FIG. 2. The login inputs can include authentication information 152 (such as a username and password). It can also include role information 154 that identifies the particular role of user 106 (or this information can be derived automatically from the authentication information). The login information can include other information 156 as well.

In response to user 106 logging in to business system 100, visualization component 114 illustratively displays practice manager homepage display 140. The information displayed on display 140 is illustratively filtered or generated based upon the particular role of user 106 (i.e., the practice manager role). Displaying the practice manager homepage is indicated by block 158 in FIG. 2.

FIG. 2A shows one embodiment of a homepage display 140. In the embodiment shown in FIG. 2A, display 140 is illustratively a panoramic display that includes a favorite chart display section 160, a charts display section 162, a KPI display section 164, a first entity display section 166, and a second entity display section 168. In the embodiment shown in FIG. 2A, display 140 is illustratively too large to be displayed all on a single display screen. Therefore, in one embodiment, a portion of display 140 indicated generated by dashed box 170, is first displayed to user 106. The user can then illustratively pan the display horizontally, in direction generally indicated by arrow 172, in order to see other portions of the homepage display 140.

In one embodiment, section 160 illustratively includes a favorite chart display element 174 that shows a chart that has been selected by user 106 to be displayed in section 160. The charts section 162 illustratively includes a plurality of different chart elements 176, that show charts that have been selected by the user to be displayed in section 162. The charts section 162 also illustratively includes an add indicator 178 that can be actuated to add another chart to section 162 on homepage display 140. The user can also use touch, mouse or other inputs to rearrange the order of the charts in section 162.

KPI display section 164 illustratively includes a plurality of display elements 180, each of which display a key performance indicator. A key performance indicator is a type of performance measurement that can be used by an organization to evaluate its success or to evaluate the success of a particular activity in which it is engaged. Success can be defined in terms of making progress toward strategic goals or the repeated periodic achievement of some operational goal. Section 164 also illustratively includes an add mechanism 182 that can be actuated by user 106 in order to add additional display elements 180 to display section 164. User 106 can also use touch or mouse or other inputs to rearrange the order of KPIs in section 164.

Each of the entity display sections 166 and 168 illustratively include display elements 184 and 186, respectively, that represent different entities 126 from business system 100. .

FIG. 2B shows one illustrative user interface display 200 that corresponds to the display portion 170 shown in FIG. 2A. Favorite chart display section 160 illustratively includes a chart display element 174 that corresponds to an underlying chart that shows revenue plotted against time. Display element 174 is illustratively an active display element that is updated as the underlying data is updated. Section 160 also illustratively includes a logo or masthead section 202 that identifies the particular company or organization that is deploying business system 100. In addition, it includes role identifier 204 that identifies the particular role of user 106, for which display 200 is generated.

Display 200 also shows a portion of charts section 162. Charts section 162 includes two different chart display elements 176 showing two underlying charts, one of which plots utilization against time and the other of which plots cost against time. Elements 176 are illustratively active display elements that are updated as the underlying data is updated. If the user pans display 200 to the right as generally indicated by arrow 206, the user will illustratively be able to see KPI display section 164 and entity display sections 166 and 168.

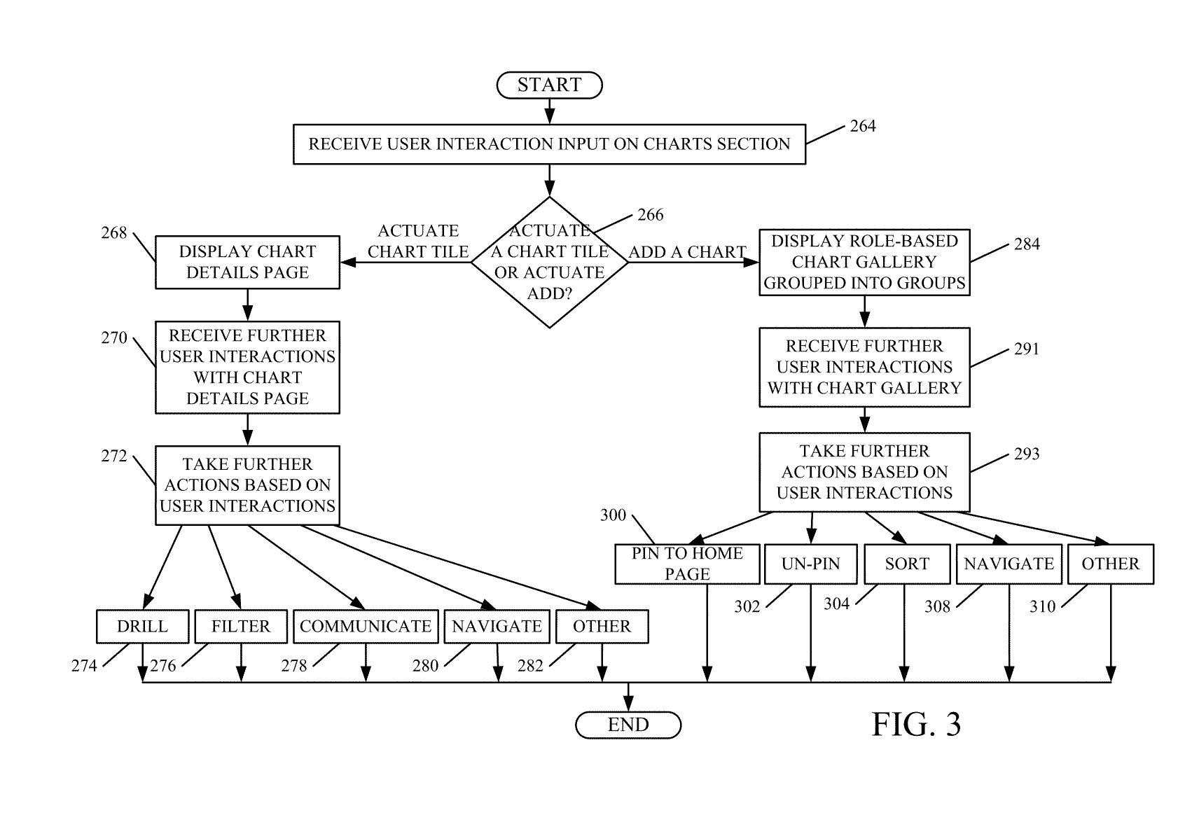

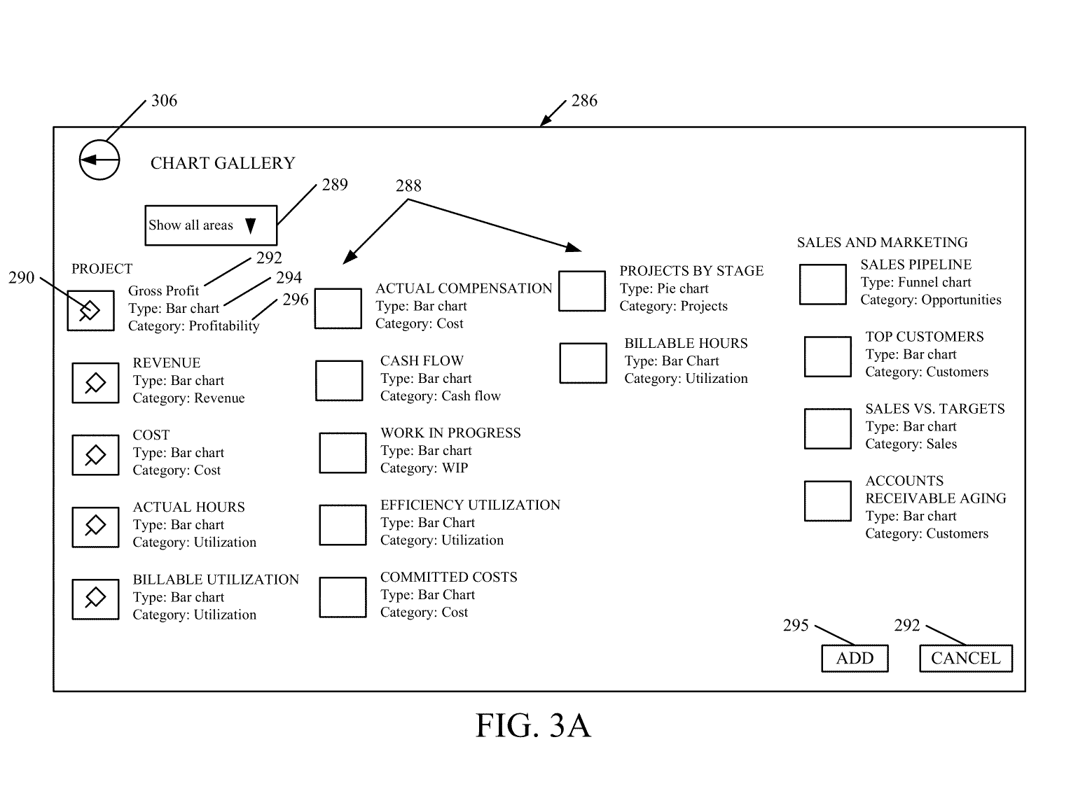

FIG. 2C shows one embodiment of a more detailed view of charts section 162. The more detailed view of charts section 162 illustratively includes a first chart display element 210 and a second chart display element 212. Section 162 shown in FIG. 2C also illustrates the add user input mechanism 178. The user interaction with charts section 162 is described in greater detail below with respect to FIG. 3.

FIGS. 2D and 2E show two exemplary display elements corresponding to key performance indicators (KPIs) in section 164 in FIG. 2A. FIG. 2D shows one embodiment of KPI display element 214. KPI display element 214 is illustratively an active tile which displays information that is updated based upon changes to the underlying information from which it is calculated.

Display element 214 in FIG. 2D shows a KPI which comprises the actual hours billed against a project. This is displayed at 216. The KPI shown in FIG. 2D also illustratively includes an indicator 218 that indicates what the goal is, in hours. Indicator 220 provides a visual indication as to whether the actual amount 216 is ahead of, or behind, the goal amount 218. In the embodiment shown in FIG. 2D, indicator 220 illustratively shows that the actual amount of hours billed is ahead of goal. Display element 214 also illustratively includes a trend indicator 222 which indicates the trend of the KPI 216, relative to its goal. For instance, recent historical data can be used by business intelligence component 124 to calculate whether the recent trending information shows that the hours are likely to remain ahead of goal, or to fall behind goal. The display items on display element 214 are illustrative only.

Display element 224, shown in FIG. 2E, is also a KPI display element. It displays the value of a measure, along with its performance measured against a prior period and a budgeted amount. For instance, display element 224 displays a KPI which is actual cost, at 226. The actual cost is compared against a prior period (e.g., the previous month) and the result of this comparison is displayed at 228. In addition, the actual cost displayed at 226 is compared against the budgeted amount, and the result of this comparison is shown at 230. Again, display element 224 is illustratively active in that it is updated as the underlying data is updated.

It will be noted that the chart display elements shown in FIG. 2C and the KPI display elements shown in FIGS. 2D and 2E are exemplary only, and a wide variety of other display elements (both chart display elements and KPI elements and other display elements) can be displayed as well. All of these are contemplated herein.

Referring again to the flow diagram of FIG. 2, once the practice manager homepage display 140 is displayed for user 106, the user 106 can interact with the homepage display in a wide variety of different ways. Receiving a user interaction input is indicated by block 232 in the flow diagram of FIG. 2. For instance, user 106 can pan the homepage horizontally to view other sections of the homepage display which are not currently in view. This is indicated by block 234 in FIG. 2. User 106 can also interact with the various sections of the homepage display. For instance, the user can interact with the charts section (either the favorite chart section 160 or the general charts section 162). This is indicated by block 236 in FIG. 2. User 106 can interact with the KPI section 164. This is indicated by block 238. User 106 can also interact with a entity sections 166 and 168. This is indicated by block 240. The user can interact with the homepage display in other ways as well, and this is indicated by block 242.

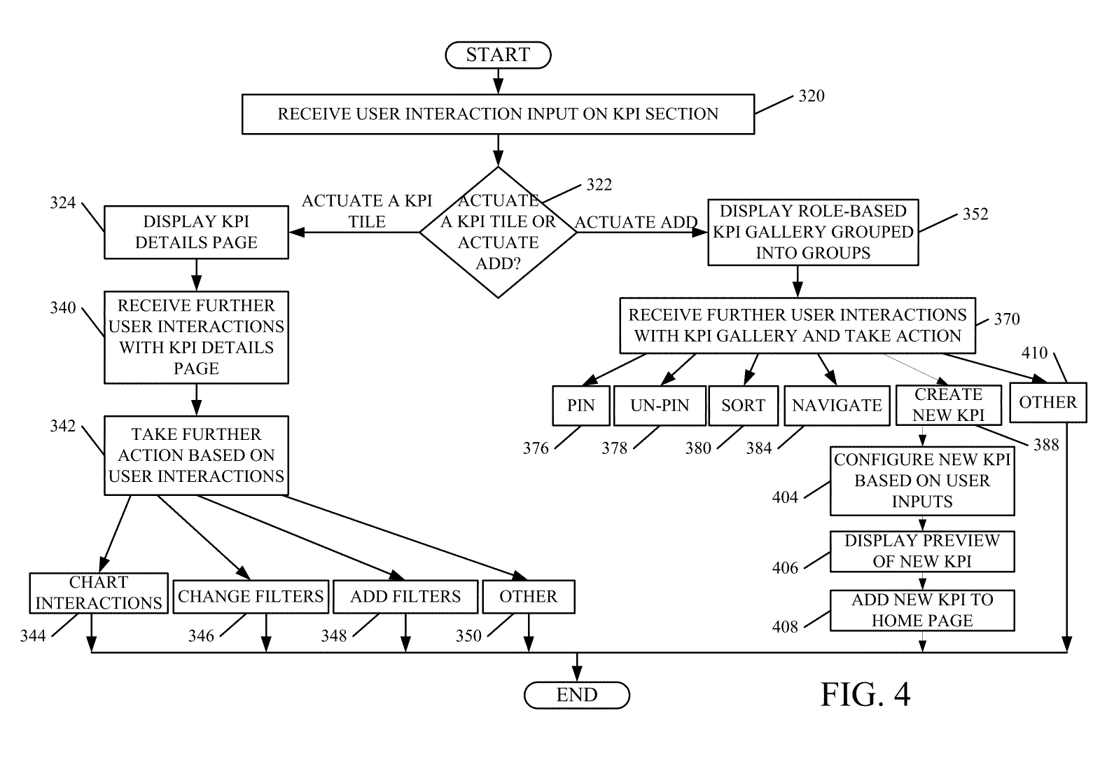

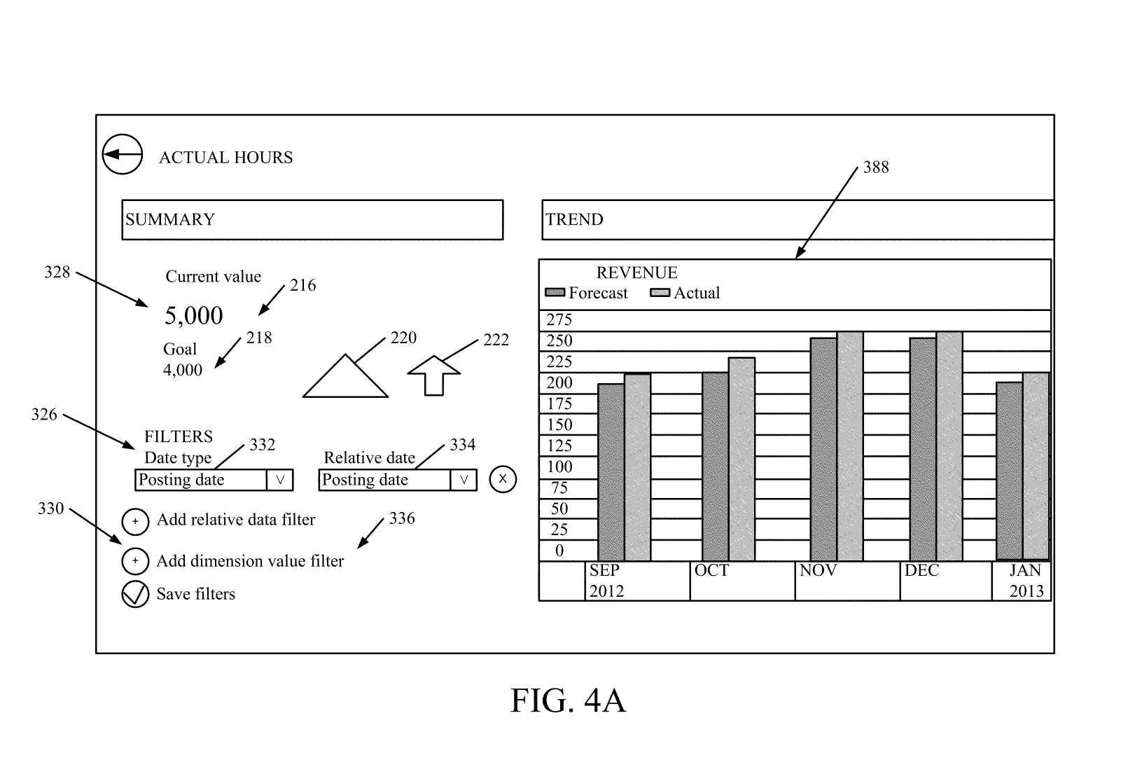

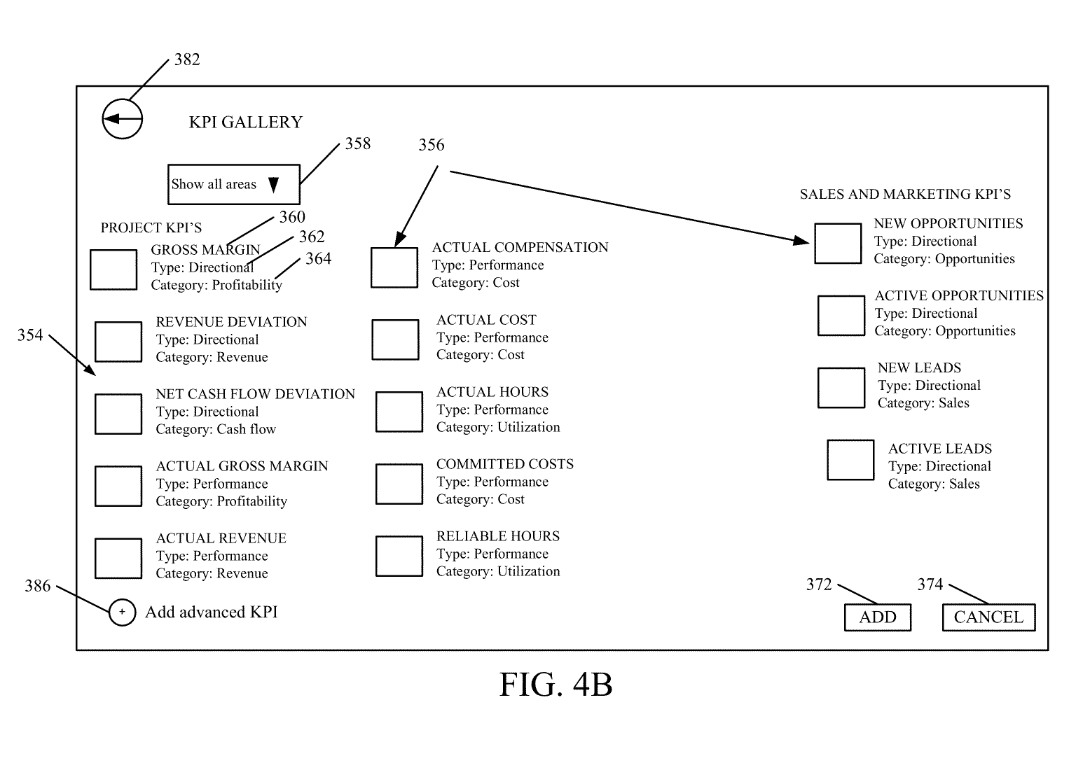

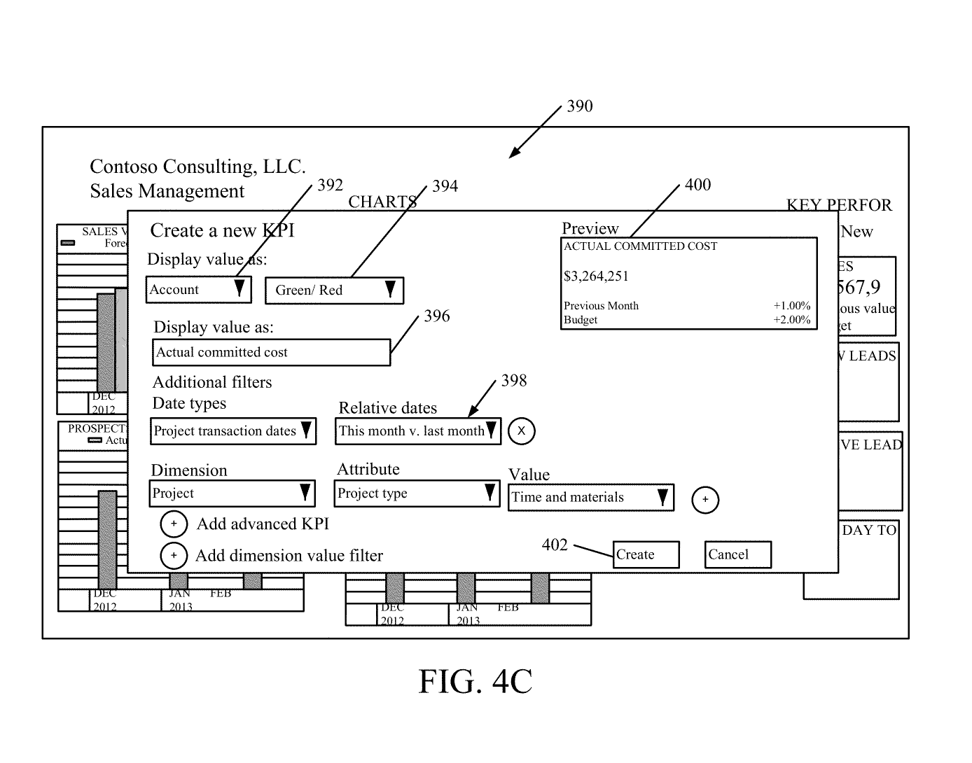

Once the user has interacted with the homepage display, visualization component 114 illustratively performs operations or takes various actions, based upon the particular user interaction that was received. This is indicated by block 244. A number of these specific interactions are described below with respect to the flow diagrams of FIGS. 3 and 4.

Before describing those, however, it will be noted that user 106 can also provide a role switching input to switch roles. In response, role switching component 122 controls visualization component 114 to display another homepage display, corresponding to the new role that was input by the user. Switching roles is indicated by block 246 in FIG. 2.

FIG. 2F shows one embodiment of another homepage display 248 that corresponds to the user inputting a sales management role. It can be seen that the user's favorite chart 250, the chart display elements displayed in charts display section 162, and the KPIs displayed in KPI display section 164 are now different. In one embodiment, they are more related to the sales management role than to the practice management role.

The user can provide the role switching input in a variety of different ways. FIG. 2G shows one embodiment of user interface display 252 that indicates this. User interface display 252 is similar to user interface display 200 shown in FIG. 2B, and similar items are similarly numbered. However, it can be seen in FIG. 2G, that the user has invoked an application bar 254. Application bar 254 includes a roles user input mechanism 256 which, when actuated by the user, displays a fly out bar 258 that, itself, displays user actuable input mechanisms 260 and 262 that correspond to the two different roles that can be assumed by user 106. User actuable input mechanism 266 corresponds to the practice manager role and user actuable input mechanism 262 corresponds to the sales manager role. When the user actuates either of the input mechanisms 260 or 262, role switching component 122 controls visualization component 114 to generate the corresponding role-specific homepage display for user 106.

FIG. 3 is a flow diagram illustrating the operation of one embodiment of business system 100 in receiving user interactions with chart section 162 (such as the chart section 162 shown in FIG. 2C). Visualization component 114 first receives a user interaction with chart section 162. This is indicated by block 264 in the flow diagram of FIG. 3. In one embodiment, the user can interact with chart section 162 by either actuating one of the chart display elements 210 or 212, or by actuating the add user input mechanism 178. Determining which user action is taken is indicated by block 266 in the flow diagram of FIG. 3.

It will first be assumed that the user has actuated one of the chart display elements 210 and 212. When this happens, visualization component 114 illustratively navigates the user to a more detailed chart display corresponding to the actuated chart display element. For instance, if the user actuates chart display element 210 (such as by clicking on it or tapping on it on a touch sensitive display), then an interactive chart details page is displayed which displays the chart represented by display element 210 in a larger form so that it can be more easily viewed, and interacted with, by user 106. Displaying the chart details page is indicated by block 268 in the flow diagram of FIG. 3.

Visualization component 114 can then receive further user interactions on the chart details page. Visualization component 114 performs corresponding actions, based upon the user interactions that are received on the chart details page. Receiving further user interactions on the chart details page and then taking additional action based upon those user inputs is indicated by blocks 270 and 272, respectively.

As examples, if the user touches one of the columns in the chart represented by display element 210 (when it is displayed on the chart details page), then visualization component 114 illustratively navigates the user to a list page showing a list of projects, workers, or other items that make up the data which represents that column If the user then further actuates an item on the list page, the user is illustratively navigated to a details page corresponding to that list items. Thus, the user can drill down to more detailed information, in this way. This is indicated by block 274 in FIG. 3.

The user can also illustratively filter the information displayed on the chart using various dimensions (such as project type, worker type, date, etc.). Filtering the information is indicated by block 276. The user can illustratively initiate communication with other individuals, and this is indicated by block 278. For instance, the user 106 can illustratively initiate messaging communication, an electronic mail message, a telephone call, etc., to another user.

In another embodiment, user 106 can navigate to other displays, as indicated by block 280, or perform other interactions that result in visualization component 114 taking other actions as well. This is indicated by block 282 in FIG. 3.

If, at block 266, instead of actuating a chart display element 210 or 212, user 106 instead actuates user input mechanism 178 to add a chart display element to the charts section 162, visualization component 114 illustratively accesses business data store 108 and displays a role-based chart gallery. This is indicated by block 284 in FIG. 3.

FIG. 3A shows one illustrative embodiment of a display 286 that shows a chart gallery. In the embodiment shown in FIG. 3A, the chart gallery includes a plurality of display elements 288, each corresponding to a different, pre-defined chart, that can be pinned to the project manager homepage display 140 for user 106. Therefore, the user can select from among the various display elements 288 to add chart display elements to the charts section 162 of the user's homepage display. The elements are illustratively grouped on the chart gallery into groups. The groups shown in FIG. 3A show a “project” group and a “sales and marketing” group. The charts can be regrouped either by the user manually moving one of display elements 288 to a different group, or by changing the subject matter or other grouping criteria upon which the charts are grouped.

The display of the display elements 288 in the chart gallery can be resorted by actuating sorting mechanism 289. Mechanism 289 is shown as a drop down menu which allows the user to select the various display criteria used to sort and group display elements 288 on the chart gallery. Of course, mechanism 289 can be a wide variety of other use input mechanisms as well, and the drop down menu is shown for the sake of example only. When the user selects the sort criteria, sorting component 120 (shown in FIG. 1) resorts the display elements according to those criteria and visualization component 114 displays them that way.

It will also be noted that, in one embodiment, the pre-defined charts represented by display elements 288 are chosen and displayed in the chart gallery based on the user's role. Therefore, if the user is logged in as a practice manager, the display elements 288 in the gallery will be for a first set of corresponding charts. However, if the user logs in as a sales manager or under a different role, then the display elements 288 can correspond to a different set of charts.

In the embodiment shown in FIG. 3A, each of the display elements 288 in the gallery can also include a “pinned” visual indicator 290 that indicates whether the corresponding chart is already pinned to the charts section 162 of the user's homepage. Thus, in the embodiment shown in FIG. 3A, it can be seen that the charts corresponding to “gross profit”, “revenue”, “cost”, “hours”, and “billable utilization” have already been pinned to charts section 162 for the homepage display of user 106.

Each display element also illustratively includes a title 292 that is the title of the chart, a chart type 294 that indicates the type of chart (such as bar chart, pie chart, funnel chart, etc.) and a category 296 that indicates a business category into which the chart falls (such as profitability, cost, revenue, cash flow, utilization, customers, opportunities, etc.). User 106 can then interact with the chart gallery shown in FIG. 3A, and visualization component 114 will take further actions based on the particular way in which the user interacts with the chart gallery. Receiving further user interaction is indicated by block 291 in the flow diagram of FIG. 3 and taking the further action is indicated by block 293.

The user can pin one of the charts corresponding to a given display element 288 to the charts section 162 of the user's homepage by selecting the given display element 288 and actuating the add button 298 on display 286. The user can remove a chart from a homepage display by selecting the chart and actuating cancel button 292. Pinning one of the pre-defined charts to the homepage of user 106 is indicated by block 300. Unpinning a chart is indicated by block 302. Resorting display elements 288 by actuating mechanism 289 is indicated by block 304. It will also be noted that the user can perform other operations, such as navigating to other displays using back button 306. This is indicated by block 308 in FIG. 3. Performing other actions based on other user interactions with the chart gallery is indicated by block 310 in the flow diagram of FIG. 3.

FIG. 4 is a flow diagram illustrating one embodiment of the operation of business system 100 in processing user interactions on the KPI section 164 of homepage display 140. Receiving a user interaction on KPI section 164 (shown in FIG. 2A) is indicated by block 320 in FIG. 4. In one embodiment, the user can either actuate a KPI tile 180 on KPI section 164, or actuate the add user input mechanism 182 to add or remove tiles from KPI section 164 on the homepage display. Determining whether the user 106 actuates a KPI tile 180, or actuates mechanism 182 to add a tile is indicated by block 322 in FIG. 4.

It is first assumed that user 106 actuates one of the KPI tiles on section 164 of homepage display 140. In that case, visualization component 114 illustratively displays a KPI details page which displays additional details corresponding to the KPI display element 180 that was actuated. Displaying the details page is indicated by block 324 in FIG. 4.

FIG. 4A shows one embodiment of a user interface display 326 representative of a KPI details page that is displayed by visualization component 114. Details page 326 illustratively includes summary information 328 displayed on the KPI tile (or KPI display element) 180 corresponding to this particular KPI. In the embodiment shown in FIG. 4A, details page 326 illustratively corresponds to the KPI display element 214 shown in FIG. 2D. Thus, the summary information shown in FIG. 2D has the same numbers as that shown in the details display shown in FIG. 4A.

KPI details page 326 also illustratively includes a filter section 330. Filter section 330 illustratively includes one or more user input mechanisms 332 and 334 that allow the user to filter the data upon which the metric represented by the KPI details page is calculated. In the embodiment shown in FIG. 4A, user input mechanism 332 and 334 are drop down menus that allow the user to select the dates for which the KPI summary information is calculated. Filter section 330 also illustratively includes user input mechanisms 336 that allow the user to add filters and to save those filters as well. In the embodiment shown in FIG. 4A, page 326 also includes a chart display 338 that corresponds to the trending indicator 222. Thus, the user can see, in chart form, the underlying data that supports trend indicator 222. Because details page 326 includes chart 338, the user can perform all of the chart interactions described above with respect to FIG. 3, on chart 338, as well.

Receiving further user interactions with the KPI details page 326 is indicated by block 340 in the flow diagram of FIG. 4. Taking further actions based on the user interactions is indicated by block 342. Performing the chart interactions on chart 338 is indicated by block 344. Changing filters in filter section 330 is indicated by block 346. Adding filters is indicated by block 348 and performing other operations based on other user interactions is indicated by block 350.

Referring again to the flow diagram of FIG. 4, it is assumed at block 322 that the user has now actuated the add user input mechanism 182 (shown in FIG. 2A) on the KPI section 164 of the user's practice manager homepage. When that occurs, visualization component 114 illustratively accesses data in data store 108 and displays a role-based KPI gallery of display elements representing different pre-defined KPIs that can be displayed to the user, grouped into various groups. This is indicated by block 352 in FIG. 4.

FIG. 4B shows one embodiment of a user interface display 354 that displays a KPI gallery of pre-defined KPIs. Display 354 illustratively includes a plurality of different KPI display elements 356, each of which represent a different pre-defined KPI that can be calculated by business intelligence component 124, so that it can be displayed on the user's homepage. As with the chart gallery discussed above with respect to FIG. 3A, each of the KPI display elements 356 can be grouped into groups, based upon grouping criteria such as subject matter or other criteria. The particular way that the KPIs are sorted and displayed on display 354 can be selected by the user using sorting input mechanism 358. In the embodiment shown in FIG. 4B, mechanism 358 is a drop down menu which allows the user to select different display criteria for sorting and grouping the KPI display elements 356 shown in FIG. 4B. Of course, other user input mechanisms can be used to do this as well.

Each of the KPI display elements 356 in the KPI gallery illustratively includes a title indicator 360, a type 362 and a category indicator 364. The title indicator shows a title for the underlying KPI that is represented by that specific display element. The type indicates the type of KPI that is to be calculated (such as a directional KPI, a performance KPI, or another type of KPI). The category indictor 364 displays a category into which the KPI fits. The categories can include, for instance, profitability, revenue, cash flow, cost, utilization, opportunities, sales, etc.).

The user can then perform a variety of different interactions with the KPI gallery display 354, and visualization component 114 performs various actions based upon those user interactions. This is indicated by block 370 in the flow diagram of FIG. 4.

For instance, the user can pin or unpin the KPIs represented by display elements 356 to the user's homepage. The user can illustratively do this by selecting one of the display elements 356 and actuating either the add user input mechanism 372 (which acts to pin the underlying KPI to the user's homepage) or the cancel user input mechanism 374 (which acts to remove it from the user's homepage). Pinning and unpinning are indicated by blocks 376 and 378 in the flow diagram of FIG. 4.

The user can change how the elements 356 are displayed on the gallery display 354. This can be done by actuating sort mechanism 358. Sorting is indicated by block 380 in the flow diagram of FIG. 4.

The user can also illustratively navigate to other displays, such as by actuating the back user input mechanism 382. Navigating is indicated by block 384 in the flow diagram of FIG. 4.

In addition, if the user wishes to see another KPI that is not already pre-defined within business system 100, the user can illustratively actuate the KPI creation user input mechanism 386. Creating a new KPI is indicated by block 388 in the flow diagram of FIG. 4. When the user does this, visualization component 114 illustratively navigates the user to a user experience controlled by new KPI generator component 118 in system 100. The user experience allows the user to select an analytical cube or module from which the KPI or other measure is calculated and to further configure the new KPI.

FIG. 4C shows one embodiment of a user interface display 390 that can be generated to allow the user to do this. It can be seen in user interface display 390 that the user can select a value using mechanism 392, and a visual indictor preference using mechanism 394. The user can select a display name using mechanism 396. The user can also set a variety of different types of filters in filter section 398 (such as date type, relative date, dimension, attribute, and value) that are used by business intelligence component 124 to filter and identify the particular data that is to be used in generating this KPI.

Display 390 also illustratively shows a preview 400 of the particular KPI display element that will be added to the user's homepage for this particular KPI. Therefore, if the user does not like the preview 400, the user can change the information using the other user input mechanisms on display 290 so that the preview 400 appears the way the user desires. Once the user has finally configured the new KPI, the user can actuate the create user input mechanism 402 to create the new KPI that has just been configured by the user.

Configuring the new KPI based on the user inputs is indicated by block 404 in the flow diagram of FIG. 4. Displaying the preview is indicated by block 406, and adding the new KPI to the user's homepage is indicated by block 408. It will be appreciated that the user can perform other interactions with the gallery display 354, and visualization component 114 will take other actions as well. This is indicated by block 410 in the flow diagram of FIG. 4.

Referring again to the user's homepage display 140 of FIG. 2A, the user can also illustratively interact with either of the entity sections 166 or 168 or to remove them. The user can actuate mechanisms 188 and 190 to add entity display elements to the entity sections 166 or 168. The user can also illustratively pivot the entity display elements 184 and 186 displayed on the user's homepage based on various attributes. For example, a project entity can be grouped by status, project type, project manager, etc.

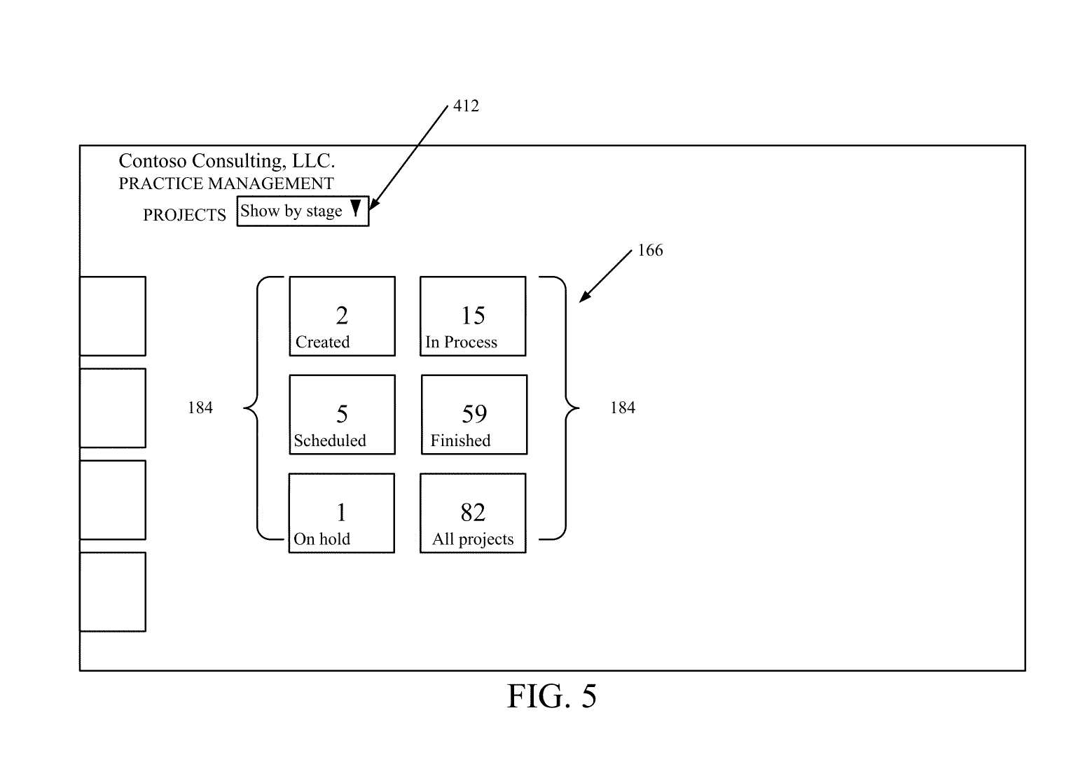

One embodiment of the entity display elements 184 in entity section 166 is shown in FIG. 5. FIG. 5 shows that each of the entity display elements in entity section 166 corresponds to an active tile that shows a count for each attribute value represented by the display element. For instance, display elements 184 show that two projects have been created, five have been scheduled, one is on hold, fifteen are in the proposal stage, fifty-nine are finished, and there are a total of eighty-two projects.

The way the particular display elements are displayed can be changed using sort mechanism 412. For instance, in the display shown in FIG. 5, the sort mechanism is set to display elements 184 grouped by project and sorted by stage. However, if they were instead sorted by project type, then the display elements 184 will include an attribute value for the various projects of different project types. Of course, this is exemplary only, and they can be sorted and shown using other criteria as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

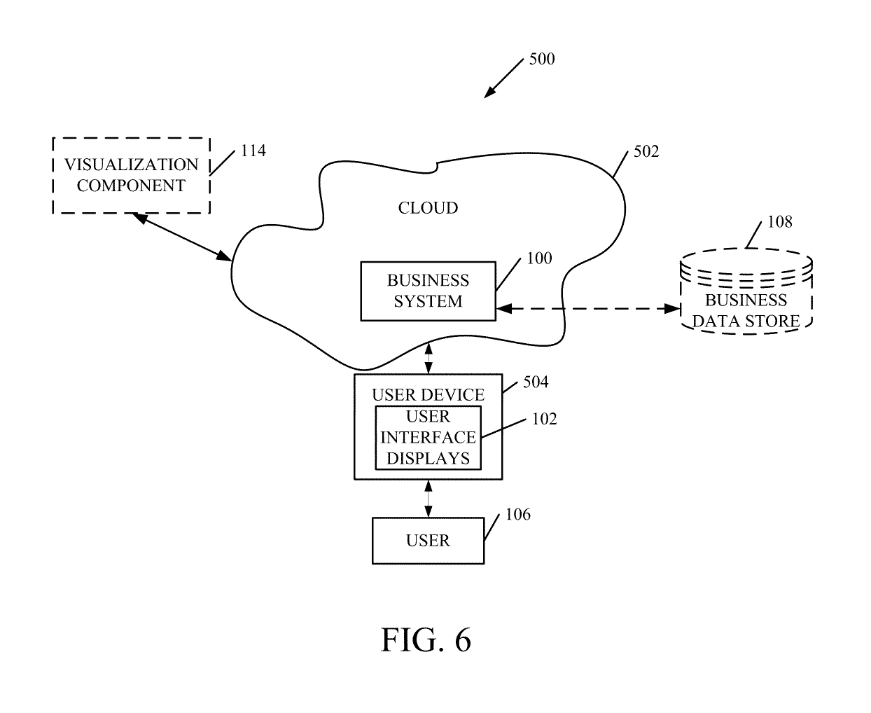

FIG. 6 is a block diagram of business system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that business system 100 is located in cloud 502 (which can be public, private, or a combination where portions are public while others are private). Therefore, user 106 uses a user device 504 to access those systems through cloud 502.

FIG. 6 also depicts another embodiment of a cloud architecture. FIG. 6 shows that it is also contemplated that some elements of system 100 are disposed in cloud 502 while others are not. By way of example, data store 108 can be disposed outside of cloud 502, and accessed through cloud 502. In another embodiment, visualization component 114 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

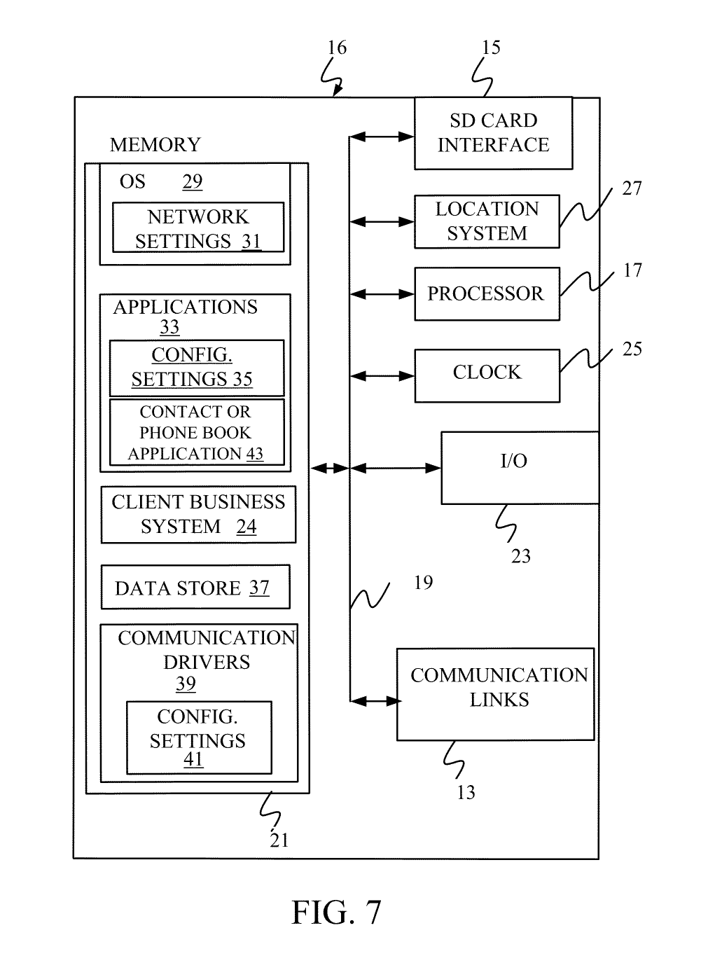

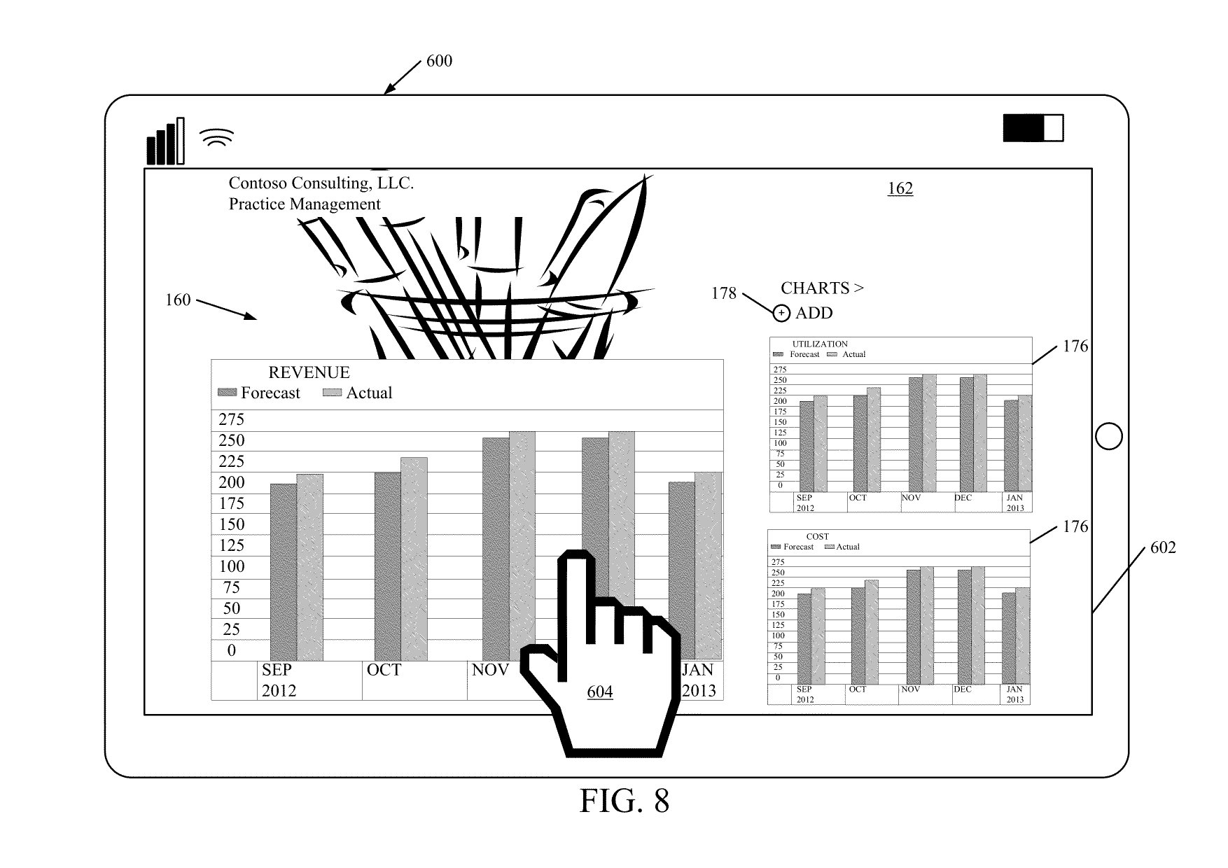

FIG. 7 is a simplified block diagram of one illustrative embodiment of a handheld or mobile computing device that can be used as a user's or client's hand held device 16, in which the present system (or parts of it) can be deployed. FIGS. 8-13 are examples of handheld or mobile devices.

FIG. 7 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 112 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one embodiment in which device 16 is a tablet computer 600. In FIG. 6, computer 600 is shown with the display from FIG. 2B displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

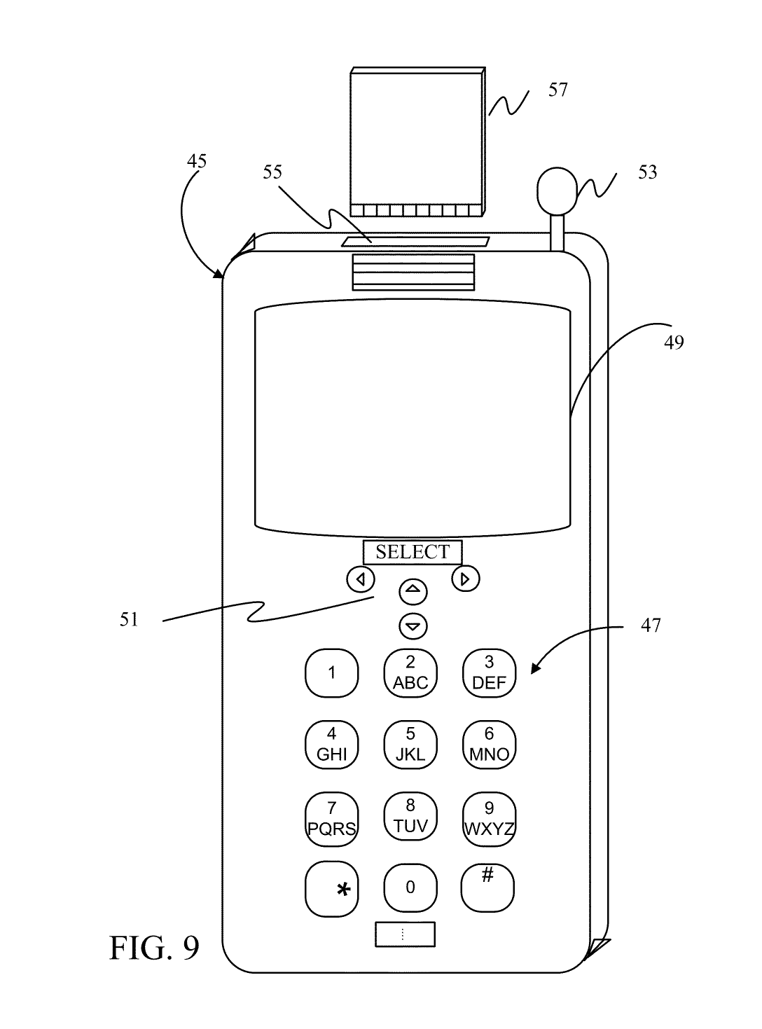

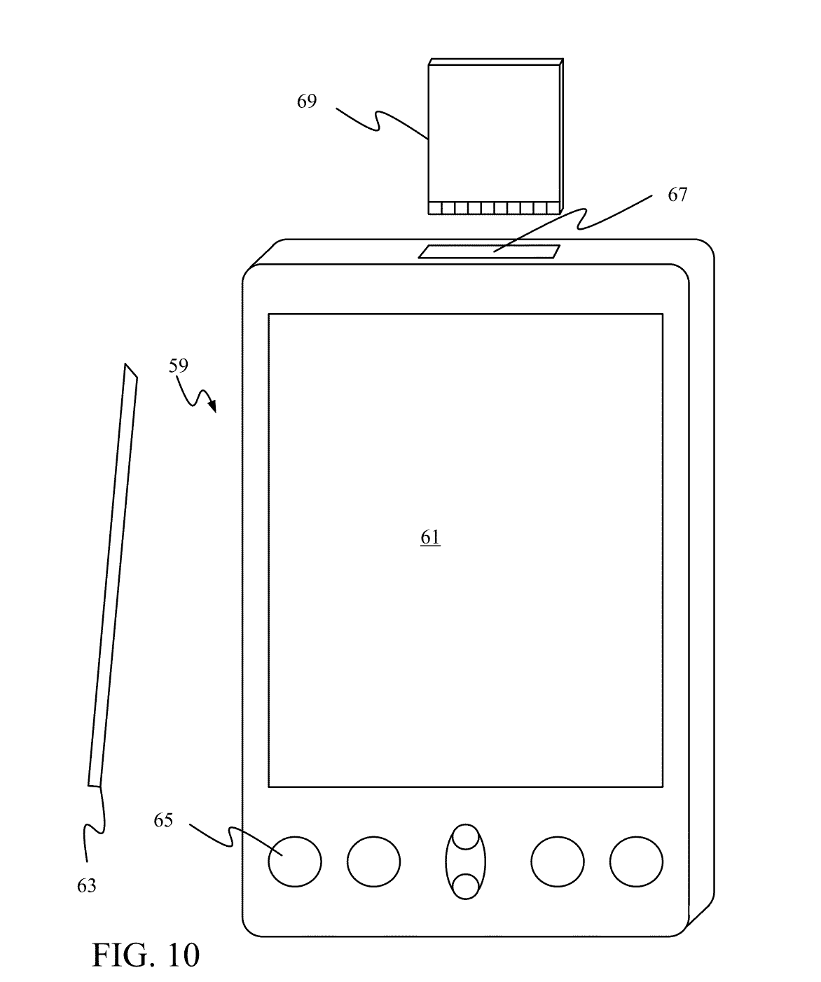

FIGS. 9 and 10 provide additional examples of devices 16 that can be used, although others can be used as well. In FIG. 9, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 10 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

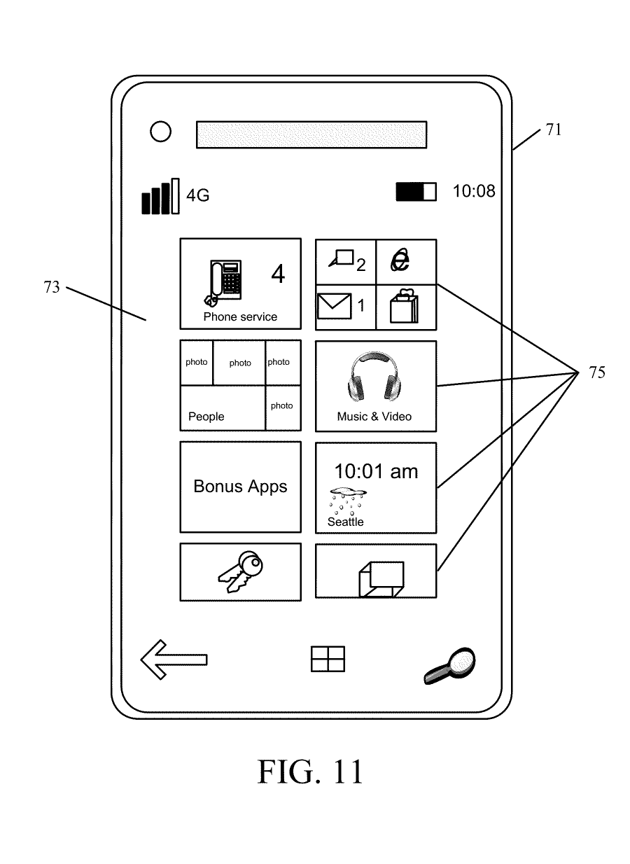

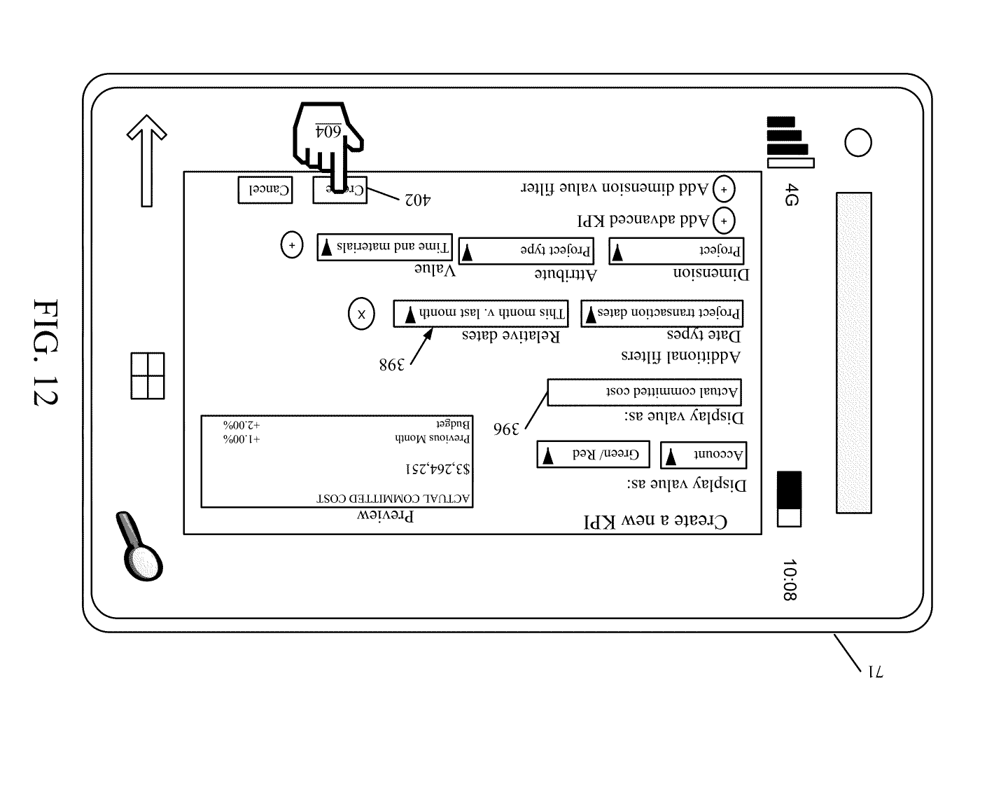

FIG. 11 is similar to FIG. 9 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 12 shows phone 71 with a part of the display from FIG. 4C displayed on it.

Note that other forms of the devices 16 are possible.

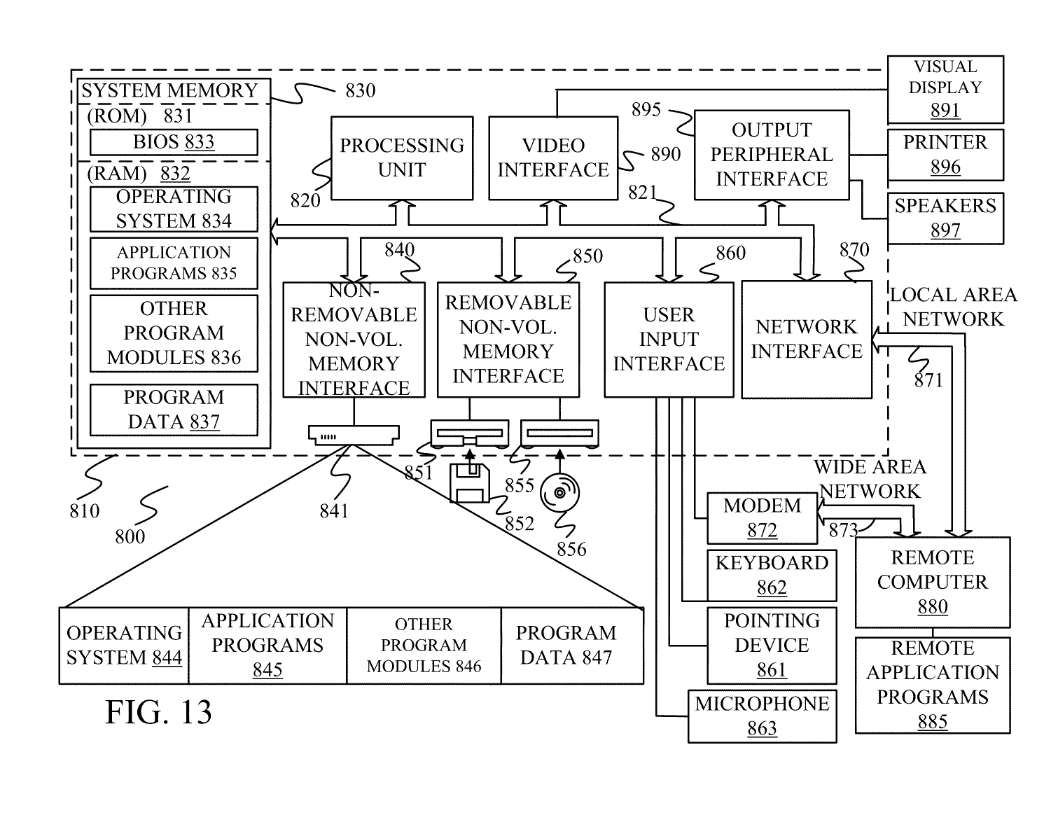

FIG. 13 is one embodiment of a computing environment in which system 100, or parts of it, (for example) can be deployed. With reference to FIG. 13, an exemplary system for implementing some embodiments includes a general-purpose computing device in the form of a computer 810. Components of computer 810 may include, but are not limited to, a processing unit 820 (which can comprise processor 124, 186 or 190), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 13 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving a user input requesting display of a home page;
displaying an interactive home page display corresponding to the user, the home page display including a first group of user actuatable analytical display elements that display a first analytical indicator indicative of pre-defined analysis on a first set of underlying data, the first analytical indicator automatically updating as the first set of underlying data is updated, the home page display further including a second group of user actuatable analytical display elements that display a second analytical indicator indicative of performance metrics calculated based on a second set of underlying data, the second analytical indicator updating as the second set of underlying data is updated;
in response to receiving user actuation of a given analytical display element in the first group, displaying a detail display showing detail information corresponding to the first set of underlying data; and
in response to receiving user actuation of a given analytical display element in the second group, displaying a detail display showing detail information corresponding to the second set of underlying data.

2. The computer-implemented method of claim 1 wherein displaying the interactive home page display comprises:
displaying a plurality of entity sections, each entity section displaying a plurality of user actuatable entity display elements, each entity display element corresponding to an underlying entity; and
in response to receiving user actuation of a given entity display element, displaying an entity details display showing information for the corresponding, underlying entity.

3. The computer-implemented method of claim 2 wherein displaying the interactive home page display comprises:
displaying a home page screen that includes a preselected chart display element that shows a chart view of a corresponding, preselected chart; and
in response to receiving user actuation of the preselected chart display element, displaying an interactive view of the corresponding chart.

4. The computer-implemented method of claim 1 wherein displaying the home page display comprises:
displaying the first group of user actuatable analytical display elements as chart display elements, the first analytical indicator on each chart display element showing a chart view corresponding to an underlying chart.

5. The computer-implemented method of claim 4 wherein displaying the detail display showing detail information corresponding to the first set of underlying data comprises:
in response to receiving user actuation of a given chart view, displaying an interactive display of the corresponding, underlying chart.

6. The computer-implemented method of claim 5 wherein displaying the home page display comprises:
displaying a first add user input mechanism corresponding to the chart display elements;
in response to receiving user actuation of the first add user input mechanism, displaying a chart gallery of pre-defined chart display elements, each corresponding to a different underlying, pre-defined chart; and
displaying a pinning user input mechanism that is actuated to place a corresponding pre-defined chart display element from the chart gallery in the first group of user actuatable analytical display elements on the home page display.

7. The computer-implemented method of claim 6 displaying the home page display comprises:
receiving a chart rearrangement user input; and
rearranging an order of the client display elements based on the chart rearrangement user input.

8. The computer-implemented method of claim 1 wherein displaying the home page display comprises:
displaying the second group of user actuatable analytical display elements as key performance indicator (kpi) display elements, the second analytical indicator on each kpi display element showing a current measure of the kpi calculated based on the second set of underlying data.

9. The computer-implemented method of claim 8 wherein displaying the home page display comprises:
receiving a kpi rearrangement user input; and
rearranging an order of the kpi display elements based on the rearrangement user input.

10. The computer-implemented method of claim 8 wherein displaying the kpi display elements comprises:
displaying a current goal for the kpi; and
displaying a trend indicator indicative of a current trend of the kpi.

11. The computer-implemented method of claim 8 wherein displaying the kpi display elements comprises:
displaying a budgeted display indicator indicative of how the current measure for the kpi compares against a currently budgeted amount for the kpi.

12. The computer-implemented method of claim 11 wherein displaying the kpi display elements comprises:
displaying a prior period display indicator indicative of how the current measure for the kpi compares against a prior period measure for the kpi.

13. The computer-implemented method of claim 8 displaying a detail display showing detail information corresponding to the second set of underlying data comprises:
showing a kpi detail display with a set of filter user input mechanisms that are actuated to change the second set of underlying data upon which the kpi is calculated.

14. The computer-implemented method of claim 8 wherein displaying the home page display comprises:
displaying a second add user input mechanism corresponding to the kpi display elements;
in response to receiving user actuation of the second add user input mechanism, displaying a kpi gallery of pre-defined kpi display elements, each corresponding to a different underlying, pre-defined kpi; and
displaying a pinning user input mechanism that is actuated to place a corresponding pre-defined kpi display element from the kpi gallery in the second group of user actuatable analytical display elements on the home page display.

15. The computer-implemented method of claim 14 wherein displaying the kpi gallery comprises:
displaying a kpi creation user input mechanism; and
in response to receiving user actuation of the kpi creation user input mechanism, displaying a set of kpi configuration user input mechanisms that are actuated to create a new kpi and a new kpi display element.

16. The computer-implemented method of claim 15 wherein displaying the set of kpi configuration user input mechanisms comprises:
displaying a kpi display element preview that displays a preview of the new kpi display element based on user configuration inputs received at the set of kpi configuration user input mechanisms.

17. A computer system, comprising:
an intelligence component that calculates a first analytical indicator by performing first pre-defined analytics on a first set of underlying data and a second analytical indicator by performing second pre-defined analytics on a second set of underlying data;
a visualization component that displays an interactive home page display corresponding to a user, the home page display including a first user actuatable analytical display element that displays the first analytical indicator, the visualization component automatically updating the first analytical indicator as the intelligence components updates the calculation of the first analytical indicator, the home page display further including a second user actuatable analytical display element that displays the second analytical indicator, the visualization component automatically updating second analytical indicator as the intelligence component updates calculation of the second set analytical indicator, the visualization component receiving user actuation of the first analytical display element and displaying a detail display showing detail information corresponding to the first set of underlying data, the visualization component receiving user actuation of the display element in the second group and displaying a detail display showing detail information corresponding to the second set of underlying data; and
a computer processor that is a functional part of the system and activated by the intelligence component and the visualization component to facilitate calculating and displaying.

18. The computer system of claim 17 and further comprising:
a role switching component that receives a role switching user input and controls the visualization component to display the home page display using role-specific display elements based on the role switching user input.

19. A computer readable storage medium that stores computer executable instructions which, when executed by a computer, cause the computer to perform steps comprising:
displaying an interactive home page display corresponding to a user, the home page display including a home page screen section that includes a preselected chart display element that shows a chart view of a corresponding, preselected chart, a chart section with a group of user actuatable chart display elements that each display a chart indicative of pre-defined analysis on a first set of underlying data, the chart automatically updating as the first set of underlying data is updated, the home page display further including a key performance indicator (kpi) section with a group of user actuatable kpi display elements that each display a kpi calculated based on a second set of underlying data, the kpi automatically updating as the second set of underlying data is updated, the home page display further comprising a plurality of entity sections, each entity section displaying a plurality of user actuatable entity display elements, each entity display element corresponding to an underlying entity, the kpi section including a kpi add input mechanism; and
in response to receiving user actuation of the kpi add input mechanism, displaying a kpi gallery of pre-defined kpi display elements each corresponding to a different, pre-defined kpi, and a pinning input mechanism that is actuated to add a selected one of the pre-defined kpi display elements in the gallery to the kpi section of the home page display.

20. The computer readable storage medium of claim 20 wherein displaying the home page display comprises:
displaying a chart add user input mechanism in the chart section;
in response to receiving user actuation of the chart add user input mechanism, displaying a chart gallery of pre-defined chart display elements, each corresponding to a different underlying, pre-defined chart; and
displaying a pinning user input mechanism that is actuated to place a corresponding pre-defined chart display element from the chart gallery in the chart section on the home page display.
